(19) United States
(12) Patent Application Publication
(10) Pub. No.: US 2004/0096626 A1
(43) Pub. Date: May 20, 2004

(54) Layered structures with enhanced properties

(75) Inventor: Jose Filipe Elias de Azevedo, Vila Nova da Telha (PT)

Correspondence Address: BAKER & HOSTETLER LLP, Washington Square, Suite 1100, 1050 Connecticut Avenue, N.W., WASHINGTON, DC, 20036, US

(73) Assignee: EPOLI-Espumas de Polietileno SA

(21) Appl. No.: 10/293,695

(22) Filed: Nov. 14, 2002

(51) Int. Cl. B32B 3/10

(52) U.S. Cl. 428/136; 428/35.7

(57) ABSTRACT

The invention relates to layered structures with enhanced physical properties, which can be used in the areas of packaging, athletics, water sports, and construction. In general, the structures are laminated polymer articles that include a layer of a low density foam and one or more layers of relatively high density material. The high density layers provide improved physical properties to the foam structures, by improving the flexural strength, resistance to bending, and resulting damage from bending in the laminated foam structure and/or having a region that expands, while the high density material, for example, modestly increases the weight of the laminated structure. Uses of the foam structures include, but are not limited to, packaging materials, gym mats, body boards, or eaves fillers. The high density material can act as a hinge and/or expansion joint or region to fold a die cut piece into a collapsible packaging system.

### FIELD OF THE INVENTION

The invention relates to polymer foams. In particular, the invention relates to polymer foams having low densities with enhanced physical properties.

### BACKGROUND OF THE INVENTION

Foam structures are useful in the areas of packaging, athletics, water sports, and construction. In general, the foams are low density polymeric materials with good physical properties that are capable of supporting loads without adverse deformation. In general, the physical properties required by these applications suggest the use of high density foams. It is generally required that the foams have good proportional limit, compressive properties, shear properties, fatigue properties, and buckling limits, as defined, for example, in “Machinery's Handbook,” E. Oberg, et al., Green, Ed., Industrial Press Inc., New York, 1992, pages 166, 168 and 253.

Physically-blown foams, particularly foams with enhanced physical properties are useful, for example, in packaging, automotive, construction, contact sports, water sports, exercise, and appliance applications. It is important to maintain good foam properties (e.g., cushioning and resistance to creasing) at low foam densities.

Packaging design has focused on the use of systems such as end caps, which fit on opposite ends of the packaged product (e.g., televisions, computers, and electronic equipment, or high value artifacts such as glass vases or fragile art work) and suspend the product in the center of a container during shipping and storage. Previous suspension-type packaging systems have been composed of corrugated or paperboard materials, molded low density foams such as polystyrene, protective films or sheeting, wood, plastic, organic or inorganic fill, or combinations of the above materials that are glued together. Molded packaging materials, such as styrofoam or polyolefin end caps, are bulky to transport and store. It is most desirable for the structure to provide the required packaging protection with the lowest amount of added weight.

### SUMMARY OF THE INVENTION

The invention features laminated foam structures having enhanced physical properties, making them useful in the areas of, e.g., packaging, athletics, water sports, and construction. In general, these structures include one or more layers of a relatively low density foam and one or more layers of a relatively high density material. The high density material is chosen from polymer resins at or near their melt density. By “near,” it is meant that the polymer resins can be reduced to about one-third of their melt density, as long as the average density of the polymeric material does not fall below about 18 pounds per cubic feet. By contrast, in accordance with this invention, a “foam” is understood to be a polymer resin which has had its melt density reduced and which has an average density of less than about 18 pounds per cubic feet.

As defined in the detailed description section, it is understood that the terms “low density” and “high density” are relative to one another. Accordingly, the phrase “relatively low density” is understood to mean having an average density of less than or equal to about 18 pounds per cubic foot, preferably less than or equal to about 6 pounds per cubic foot, and more preferably less than or equal to about 4 pounds per cubic foot.

The phrase “relatively high density” is understood to mean having an average density of greater than about 18 pounds per cubic foot. Preferably, the relatively high density material has an average density ranging from about greater than 18 pounds per cubic foot to about the melt density or related specific gravity of the non-foam plastic material. For example, if the high-density material chosen is low-density polyethylene, the average density could range up to the melt density corresponding to its specific gravity of about 0.910 to about 0.924. Thus, the average density could range up to from about 56.8 to about 57.7 pounds per cubic foot. As another example, higher density polyethylenes, which have larger specific gravities, for example ranging from about 0.950 to about 0.960, could be used. In such cases, the melt density would be greater than 57.7 pounds per cubic foot and therefore the average density could be greater than 57.7 pounds per cubic foot. Also, other plastic resins could be used with specific gravities greater than one. In such cases the average density could range up to about 62 pounds per cubic foot or more. Further, the “high density” layers have an average density at least 1.5 times greater than the low-density layers and a volume at least 1.5 times smaller than the low density layer or layers. The core is a structure having one or more layers.

The term “about” is used to take in account inherent measuring inaccuracies and is understood to modify recited measurements hereinafter.

The low density foam layer can be a base, central, or an inner layer, (each term, hereinafter “core”) of the polymeric structure. The high density layer provides improved physical properties to the foam structures by, for example, improving the flexural strength, resistance to bending (or crimping), and resulting damage from bending in the composite structure.

The high density layer also permits the foam structures to be printed with text and/or elaborate graphics. The graphics may be colored. The foam structures have improved stiffness, resist creasing, and more effectively dissipate loading forces of the foam. The outer surface of the foam structures is smooth and flat relative to the surface of the low density case. The low density layer provides a relatively low-weight product that uses relatively small amounts of polymer material. The composite structure can be die cut so that the higher density layer on the outside of the structure can act as a hinge allowing the die cut piece to be folded to make a collapsible packaging system. Examples of physically-blown foams are described in U.S. Ser. No. 08/638,122, filed Apr. 26, 1996, and entitled “Cross-Linked Low-Density Polymer Foam”, and U.S. Pat. No. 5,589,519 issued Dec. 31, 1996, and entitled “Process of Extruding Lightly Crosslinked Polyolefin Foam”, which are incorporated herein by reference.

The use of certain dimensional stabilization compounds, disclosed in U.S. Pat. No. 5,874,024 issued Feb. 23, 1999, and entitled “Stability Control Agent Composition for Polyolefin Foam”, which is incorporated herein by reference, are useful when processing foamable polyolefin compositions and formulation comprising at least one compound that is a partial ester of fatty acid with polyol, and at least one compound selected from the group consisting of higher alkyl amines, fatty acid amides and/or complete esters of higher fatty acids.

Foams can also be manufactured in a continuous process by making moldable foam beads comprising a non-crosslinked or crosslinked thermoplastic polymer foam, which are produced by mixing a composition comprising a non-crosslinkable or crosslinkable thermoplastic polymer or a thermoplastic polymer with a crosslinking agent, additives to achieve specific properties, a blowing agent, extruding the admixture under pressure, crosslinking, when applicable, the admixture under pressure, modulating the admixtures temperature to achieve the desired foaming properties, and then expanding the admixture in a zone of lower pressure to form a foam bead that can be molded.

This method is disclosed in U.S. Pat. No. 5,605,937 issued Feb., 25, 1997, and in U.S. Pat. No. 5,763,498 issued Jun. 9, 1998, both entitled “Moldable Thermoplastic Polymer Foam Beads”, which are incorporated herein by reference. The moldable foam beads are subsequently heated and fused together in a mold to form a foam product, which can have a multiple of shapes depending on the shape of the mold's internal cavity. Some of the shapes that can be made, including a flat plank shape, are suitable for being incorporated in this invention as a core or exterior laminate of the core.

In one aspect, the invention features a composite structure that includes a first high density article laminated to a first surface of a second article and a third high density article laminated to a second surface of the second article. The second article is a core made from foam. The first and the third high density articles each have an average density greater than about 18 pounds per cubic foot and a thickness that is at least 1.5 times smaller than the second article. The flexural stiffness of the laminated foam structure is 2-20 times higher than the flexural stiffness of the second article that is a core made from foam. Flexural stiffness can be determined directly from beam bending tests.

In preferred embodiments, the second article is a laminated foam article including at least two foams. Each of the two foams have an average foam density of less than about 6 pounds per cubic foot. Preferably, each of the two foams has a thickness ranging from one-fourth of an inch to about 4 inches. It is preferred that the first and the third high density article each have an average density greater than about 18 pounds per cubic foot. Preferably, each of the first and the third high density articles has a thickness ranging from 0.0005 to about 0.100 inches.

In another preferred embodiment, the second article is a non-laminated foam article. The foam has an average foam density of less than about 6 pounds per cubic foot. Preferably, the foams has a thickness ranging from one-fourth of an inch to about 8 inches and is, for example a continuously extruded type of foam, a molded bead type of foam, or a reaction injection molded type of foam. It is preferred that the first and the third high density article each have an average density greater than about 18 pounds per cubic foot. Preferably, each of the first and the third high density articles has a thickness ranging from 0.0005 to about 0.100 inches.

Preferably, the second foam article has an average foam density ranging from 1 to 6 pounds per cubic foot, the first article has a density greater than about 18 pounds per cubic foot, and the third article has a density greater than about 18 pounds per cubic foot. The first and third articles each can be laminated articles, for example including two high density layers each having an average density greater than about 18 pounds per cubic foot.

In preferred embodiments, the second article can further include a foam layer having an average foam density greater than about 4 pounds per cubic foot. Preferably, the foam layer has an average foam density ranging from about 4 to 15 pounds per cubic foot and a thickness ranging from one-sixteenth of an inch to about 4 inches.

In preferred embodiments, the structure has a total thickness ranging from three-quarters of an inch to 14 inches.

In another aspect, the invention features a laminated foam structure including a first skin laminated to a first surface of a core, and a second skin laminated to a second surface of the core. The core includes a foam having an average foam density ranging from 0.5 to 4 pounds per cubic foot, the first skin includes a first high density material and the second skin includes a second high density material, each high density material having an average density greater than 18 pounds per cubic foot and a thickness less than about one-half of an inch, and the laminated structure has a total thickness up to about 14 inches or less. The flexural stiffness of the laminated foam structure is 2-20 times higher than the flexural stiffness of the core.

In yet another aspect, the invention features a body board, which is a foam structure including either a non-laminate foam, a bead molded foam, a laminated foam, or a combination thereof. The foam structure has a core, which includes a first skin laminated to a first surface of a core, and a second skin laminated to a second surface of the core. The core includes a foam having an average foam density of ranging from 1 to about 4 pounds per cubic foot, the first skin includes a first high density material and the second skin includes a second high density material each high density material having density greater than 18 pounds per cubic foot and a thickness less than or equal to about one-half of an inch, and the structure has a total thickness of less than or equal to about 3 inches. The higher densities of the first and second skins can make the structure more resistant to mechanical damage from impact, shear, and abrasive loads due to the higher polymer and lower air content of the higher density foam.

In preferred embodiments, the first high density layer includes at least two laminated articles one of which is a high density material, another of which may be a foam. The foam layer can include at least two laminated foam articles and the third high density layer can include at least two laminated articles, one of which is a high density material and another of which may be a foam. Preferably, the foam layer has foam articles having an average foam density ranging from about 0.5 to about 4 pounds per cubic foot and a thickness ranging foam about one-fourth of an inch to about 4 inches. It is preferred that the first high density layer include a high density layer having an average density greater than 18 pounds per cubic foot and a thickness less than or equal to about ½ inch.

In another aspect, the invention features a method of increasing the flexural strength of a core foam structure, including the steps of laminating a first skin to a first surface of the core foam structure, and laminating a second skin to a second surface of the core foam structure. The first skin includes a first high density material having a density that is greater than about 18 pounds per cubic foot and a thickness that is at least 1.5 times smaller than the thickness of the core foam structure. The second skin includes a second high density layer having density that is greater than 18 pounds per cubic foot and a thickness that is at least 1.5 times smaller than the thickness of the core foam structure.

In preferred embodiments, the core foam structure can be a laminated foam article including at least two foams each having an average foam density of less than or equal to about 4 pounds per cubic foot. In other preferred embodiments, the first skin and the second skin each have a density of greater than about 18 pounds per cubic foot. Preferably, the core foam structure has an average foam density ranging from about 0.5 to about 4 pounds per cubic foot, the first skin has a foam density of greater than about 18 pounds per cubic foot, and the second skin has a foam density greater than about 18 pounds per cubic foot. The first skin and the second skin each can be laminated articles including two high density materials each having an average density of greater than about 18 pounds per cubic foot.

In other preferred embodiments, the method further includes the step of including a foam layer having an average foam density greater than about 4 pounds per cubic foot in the core foam structure.

In other preferred embodiments, the foam includes polyurethane or polystyrene or polyolefin or a combination thereof. The polyolefin includes a polyethylene or polypropylene. Preferably, the foam further includes a single-site initiated polyolefin resin. In preferred embodiments, at least a portion of the foam is cross-linked.

In another aspect, the invention features a composite structure, including a first skin laminated to a first surface of a core. The core includes a foam having an average foam density ranging from about 0.5 to about 6 pounds per cubic foot, the first skin includes a second skin having a foam density greater than about 18 pounds per cubic foot and a thickness less than or equal to about one-half of an inch, and the composite structure has a total thickness of less than or equal to about 14 inches.

In another aspect, the invention features a composite structure, including a first article laminated to a first surface of a second foam article. The first article is a high density article having an average density greater than about 18 pounds per cubic foot and a volume that is at least 1.5 times smaller than the volume of the second foam article.

In another aspect, the invention features a collapsible packaging system. The system includes a composite structure having a skin laminated to a surface of a core. The composite structure includes a first packing member connected by a hinge and/or expansion region of the composite structure to a second packing member, and the core is scored or cut entirely through in the hinged and/or expansion region to form the first and second packing members.

In preferred embodiments, the first packing member is partially defined by a slit extending entirely through the composite structure, and by a gap or a thinned region of the composite structure permitting clearance between the first and the second packing members as they move relative to one another about the hinged and/or expansion region. The first packing member can be pivoted about the hinge and/or expansion from a storage position in which the first packing member is parallel to and contained within a gap in the second packing member, to a packing position in which the first packing member is oriented transverse to the second packing member. In other preferred embodiments, the first packing member is tapered, having a wide end nearest to the first hinged and/or expansion region.

In other preferred embodiments, the composite structure further includes a third packing member attached to the second packing member by a second hinged and/or expansion region. The third packing member is partially defined by a slit extending entirely through the composite structure, and by a gap or a thinned region of the composite structure permitting clearance between the second and the third packing members as they move relative to one another about the second hinged and/or expansion region. In the storage position, both the first and the third packing member are parallel to and positioned within the second packing member. In the packing position, the first and the third packing members are generally parallel, forming a well for containing a packed item.

In other preferred embodiments, the first packing member is tapered, having a wide end nearest to the first hinged and/or expansion region and the third packing member is tapered, having a wide end nearest to the second hinged and/or expansion region. Preferably, the first packing member and the third packing member are oriented so that the first hinged and/or expansion region and the second hinged and/or expansion region are located opposite to each other on the composite structure.

In another aspect, the invention features a method of making a hinge and/or expansion region. The method includes the steps of providing a composite structure, including a skin laminated to a surface of a core, cutting through the core and the skin of the composite structure to form a first packing member, and cutting through the core of the composite structure and leaving the skin connected to the first packing member to form a first hinged and/or expansion region. The first packing member can be pivoted and/or expanded about the hinge and/or expansion region from a storage position in which the first packing member is parallel to, and contained with a gap, in the second packing member, to a packing position in which the first packing member is oriented transverse to the second packing member. In preferred embodiments, the method further includes, cutting through the core and the skin of the composite structure to form a third packing member and cutting through the core of the composite structure and leaving the skin connected to the third packing member to form a second hinged and/or expansion region, whereby the third packing member can be folded and/or expanded along the second hinged and/or expansion region. In the storage position, both the first and the third packing member are parallel to and positioned within the second packing member. In the packing position, the first and third packing members are generally parallel, forming a well for containing a packed item.

In other preferred embodiments, the first high density material structure, which is a skin, is laminated to a surface of a foam structure, which is a core, the core including at least two core elements separated by a bending and/or expansion region that is a gap or crease in the core, whereby the composite structure can be folded and/or expanded along the bending and/or expansion region.

In other preferred embodiments, the first article is a skin of high density material having an average foam density of more than 18 pounds per cubic foot and a thickness less than or equal to about one-half of an inch, and the second article is a core having an average density ranging from 0.5 to about 6 pounds per cubic foot and a thickness ranging from 0.25 to about 14 inches. More preferably, the foam core has an average foam density of less than or equal to about 4 pounds per cubic foot and the core thickness ranging from about 0.25 to about 6 inches. In other preferred embodiments, the second article has an average foam density ranging from about 10 to about 12 pounds per cubic foot and a thickness ranging from about one-sixteenth of an inch to about one-fourth of an inch. In other preferred embodiments, the first high density article includes at least two laminated high density articles.

The foam structures can include a variety of polyolefins in the composition, including single-site initiated polyolefin resins. Polyethylenes include ethylene-containing polyolefins. Single-site initiated polyolefin resins include polyolefins prepared from a single-site initiator that has controlled molecular weights and molecular weight distributions. The polyolefin can be polyethylene, polypropylene, or a copolymer of ethylene and alpha-unsaturated olefin monomers.

Copolymers include polymers resulting from the polymerization of two or more monomeric species, including terpolymers (e.g., resulting from the polymerization of three monomeric species), sesquipolymers, and greater combinations of monomeric species. Copolymers are generally polymers of ethylene with C₃-C₂₀ alpha-olefins, and/or diolefins.

The average foam densities can be measured according to ASTM-3575, for example.

The foams in the composite structures of the invention can be cross-linked. Cross-linking can occur by high energy irradiation, most preferably electron beam irradiation, peroxide treatment, or silane-grafting and cross-linking by treatment with water. Silane-grafting generally involves attaching one or more silicon-containing monomer or polymer to the original polymer chains. The use of silane-grafting for cross-linking in polymer foams is described, for example, in U.S. Ser. No. 08/308,801, filed Sep. 19, 1994, and entitled “Cross-Linked Foam Structures of Essentially Linear Polyolefins and Process for Manufacture,” which is incorporated herein by reference, and in U.S. Ser. No. 08/638,122.

Silane-grafted resins used to make foam are also disclosed in U.S. Pat. No. 5,589,519 issued Dec. 31, 1996, and entitled “Process of Extruding Lightly Crosslinked Polyolefin Foam”, and in U.S. Pat. No. 5,605,937 issued Feb., 25, 1997, and in U.S. Pat. No. 5,763,498 issued Jun. 9, 1998, both entitled “Moldable Thermoplastic Polymer Foam Beads”, which are incorporated herein by reference. The preferred foam structures contain silane-grafted cross-linked resins.

The foams of the composite structures are generally closed-cell foams. The term “closed-cell,” as used herein, means that predominantly, greater than approximately 70% of the foam cell volumes have cell walls isolating them from the external atmosphere. One way to determine this is by measuring the amount of water that is absorbed into the foam when the foam is immersed in water.

The invention can have one or more of the following advantages. The laminate structures include a core of a low density foam and one or more skins of relatively high density material covering the core which improves, for example, the flexural strength, resistance to bending, and resulting damage from bending in the composite structure. Because the skin is thin relative to the core, the overall weight of the composite structure is increased little relative to the increase obtained in the physical properties of the structure. Additional improvement in the physical foam properties can result when a high density layer is added in the center of the low density core. The high density layer can help further dissipate loading forces.

In addition to improving the overall structural properties of the composite structures, the composite structures also have an improved smoother surface with the skin. Because the skin generally has a higher average density than the core, it is generally a tougher material than the core. The “toughened” surface of the structure makes it more durable as well. Further, the high density material permits the resultant structure to be printed with text and/or elaborate graphics.

The foams, including silane-grafted single-site initiated polyolefin resins, generally have lower foam densities while retaining good strength and other physical foam properties. See, for example, U.S. Ser. No. 08/638,122. In general, by lowering the average density and improving the physical properties of the composite structures, composite structures that contain less material are obtained. Thus, the cost of the materials and the amount of wasted material is less than the cost and amount of waste associated with conventional non-laminated structures.

The composite structures can be produced in a continuous laminating operation. Moreover, the structures can be die cut quickly and efficiently, for use in a variety of applications, such as packaging. Efficient heat lamination of the skin to the core eliminates the need to bond to dissimilar surfaces with adhesives for many applications, contributing to the recyclability of the materials.

By cutting through the core layer of the composite structure and not one of the skins to form a hinge, the resulting composite structures are versatile. For example, in packaging applications, the packaging system is readily shipped in flat, collapsed position to take up less space, saving freight and storage expense, and simplifying reuse of the material.

Other features and advantages of the invention will be apparent from the following detailed description thereof, and from the claims.

### BRIEF DESCRIPTION OF THE DRAWINGS

FIG. 1 is a drawing depicting a composite structure having a low density core and two high density material skins.

FIG. 2 is a drawing depicting a composite structure having a low density core with a high density foam layer and two high density material skins.

FIG. 3 is a drawing depicting a composite structure having a low density core and two laminated high density material skins.

FIG. 4 is a drawing depicting a non-composite structure having a low density core and two high density material skins.

FIG. 5 is a drawing depicting a non-laminated composite structure having a low density core with a high density foam layer and two high density material skins.

FIG. 6 is a drawing depicting a composite structure having a low density core and one high density skin.

FIG. 7 is a drawing depicting a perspective view of a composite structure that has been die cut for a packaging application in the collapsed configuration.

FIG. 8 is a drawing depicting a bottom view of the composite structure of FIG. 7.

FIG. 9 is a drawing depicting a top view of the composite structure of FIG. 7.

FIG. 10 is a drawing depicting a side view of the composite structure of FIG. 7.

FIG. 11 is a drawing depicting a cross-sectional side view of the composite structure of FIG. 7.

FIG. 12 is a drawing depicting a perspective view of a composite structure that has been die cut for a packaging application in the expanded configuration.

FIG. 13 is a drawing depicting a top view of the composite structure of FIG. 12.

FIG. 14 is a drawing depicting a bottom view of the composite structure of FIG. 12.

FIG. 15 is a drawing depicting a cross-sectional side view of the composite structure of FIG. 12.

### DETAILED DESCRIPTION OF THE EMBODIMENTS OF THE INVENTION

The composite structures include a layer of low density foam, for example, a poymeric foam, and one or more relatively high density layers. It is understood that “low density” and “high density” are relative to one another and mean that the high density layers have: (i) an average density at least 1.5 times greater than the low density layer; (ii) a volume at least 1.5 times smaller than the low density layer; and, (iii) an absolute density greater than about 18 pounds per cubic foot.

The high density layer covers a surface of the low density foam. In general, the low density foam has a high density layer laminated on at least one surface, but can have a second high density layer laminated to another surface of the core. In general, each of the high density layers and the low density foam can be a laminated structure. The laminated structure can be produced using any conventional lamination technique, including heat, film, or adhesive lamination. The laminated construction improves the mechanical properties of the structure, such as proportional limit, compressive properties, shear properties, fatigue, and buckling.

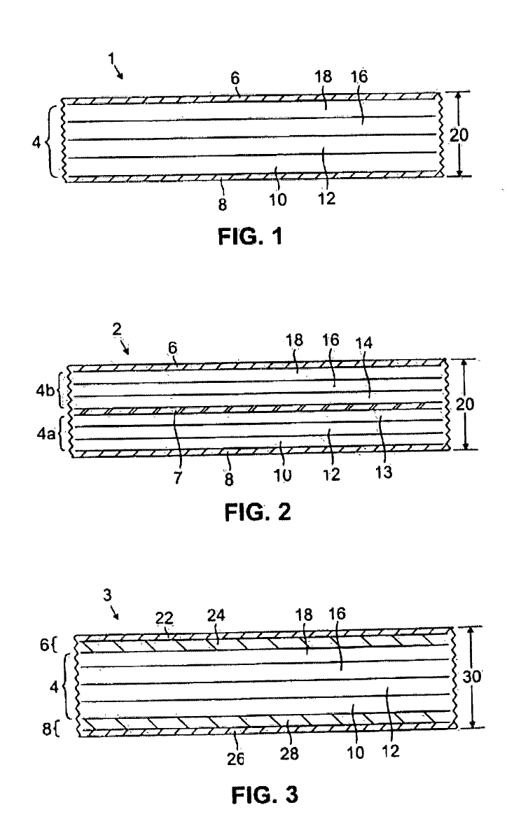

Preferably, the foam articles are foam sheets or planks which can be prepared as described, for example, in U.S. Ser. No. 08/638,122. Foam articles with a broad range in physical properties, including a broad range of average foam densities, can be prepared by the methods described therein. Particularly preferred composite structures are described and illustrated in FIGS. 1, 2, and 3.

Preferably, from a cost-saving rather than cushioning perspective, the high density layers are plastic materials with reduced specific gravity.

Referring to FIG. 1, the composite structure 1 has a low density layer 4 laminated to a first high density layer skin 6 on one surface of the low density layer 4. The core 4 is also laminated to a second skin 8 on a second surface of core 4. Skin 6 and skin 8, are generally, plastic materials with reduced specific gravity, that have average densities of greater than about 18 pounds per cubic foot and thicknesses of at least one-half of an inch or less. Core 4 is a laminated foam structure that includes multiple layers of foam. In these preferred embodiments, core 4 has four layers, including foam 10, foam 12, foam 16, and foam 18. The foams 10, 12, 16, and 18, in core 4, each have average foam densities ranging from 1.2 to 2.5 pounds per cubic foot and thicknesses ranging from three-eighths of an inch to five-eighths of an inch. Core 4, and its constituent foams 10, 12, 16 and 18, have average foam densities that are low relative to the first skin 6 and second skin 8, which have densities greater than of at least about 18 pounds per cubic foot. The structure 1 has a total thickness 20 that generally ranges from one-fourth of an inch to 14 inches. Foams according to FIG. 1 can be used in packaging applications.

Referring to FIG. 2, the composite structure 2 has a core including a low density sub-layer 4a and a low density sub-layer 4b laminated, respectively, to each surface of a relatively high density foam layer 7. The foam layer 7 is a foam having an average density of ranging from 4 to 12 pounds per cubic foot and a thickness ranging from one-sixteenth of an inch to one-eighths of an inch. Layer 7 can also be a high density material, such as a plastic material, having an average density greater than about 18 pounds per cubic foot and a thickness ranging from one-sixteenth to one-eighths of an inch. The core is laminated to a first skin 6 on one surface of the core and to a second skin 8 on a second surface of the core. Skin 6 and skin 8 are generally materials having average densities of greater than about 18 pounds per cubic foot and thicknesses of less than about one-half of an inch.

Each of the sub-layers 4a and 4b is a laminated foam structure with multiple layers. In this preferred embodiment, sub-core 4a has three layers, including foam 10, foam 12, and foam 13, and sub-core 4b has three layers, including foam 14, foam 16, and foam 18. The foams 10, 12, 13, 14, 16, and 18 in the core each have average foam densities ranging from about 1.2 to about 2.5 pounds per cubic foot and thicknesses ranging from about three-eighths of an inch to about five-eighths of an inch. Each sub-core 4a and 4b, their constituent foams, and the core, including layer 7, have average densities that are low relative to the first skin 6 and second skin 8. The structure 2 has a total thickness 20, which generally ranges from about one-fourth of an inch to about 8 inches or greater. Foams according to FIG. 2 can be used in packaging applications.

Referring to FIG. 3, the composite structure 3 has a core 4 laminated to a first skin 6 on one surface of core 4. The core 4 is also laminated to a second skin 8 on a second surface of core 4. Core 4 is a laminated foam structure with multiple layers. In this embodiment, core 4 has four layers, including foam 10, foam 12, foam 16, and foam 18, that each have average foam densities ranging from about 1.2 to about 2.5 pounds per cubic foot and thicknesses ranging from about three-eighths of an inch to about one-half of an inch. Core 4, and its constituent foams 10, 12, 16 and 18, have average densities that are low relative to the first skin 6 and second skin 8.

Skin 6 is a laminated material/structure including outer layer 22 and inner layer 24. Skin 8 is a laminated material/structure including outer layer 26 and inner layer 28. Foams 22, 24, 26, and 28 each have average densities greater than the core foam densities, at least 4 pounds per cubic foot, and the outer layers 22 and 26 having average densities higher than the inner layers 24 and 28. In preferred embodiments, each of outer layers 22 and 26 has an average density of greater than about 18 pounds per cubic foot and a thickness of about one-eighth of an inch or less and each of inner layers 24 and 28 has an average density of less than about 18 pounds per cubic foot and a thickness of about one-eighth of an inch or more.

Core 4 is a laminated foam structure with multiple layers. In these preferred embodiments, core 4, and its constituent foams 10, 12, 16 and 18, have average foam densities that are low relative to the first skin 6 and second skin 8. The structure 3 has a total thickness 30, generally ranging from about 2 to about 2 and one-half of an inch. Foams according to FIG. 3 can be used in water sports as body boards or kick boards, in exercise equipment (e.g., as gym mats), and in construction applications as eaves fillers.

The preferred foams are polyethylene foams that are described, for example, in U.S. Ser. No. 08/638,122. The preferred skins are materials that have average densities greater than about 18 pounds per cubic foot, preferably ranging from about 18 to about 40 per cubic foot, and thicknesses ranging from about 0.0005 to about one-half of an inch. Most preferably, the skins have average densities of from about 18 to about 40 per cubic foot, and thicknesses of from about 0.002 of an inch to about 0.030 of an inch. The preferred core is a foam with an average foam density of less than about 4 per cubic foot, preferably ranging from about 1.2 to about 2.5 per cubic foot. The core is a laminated foam structure with multiple foam layers each having thicknesses ranging from about one-fourth of an inch to about five-eighths of an inch. The laminated foam structure, preferably, has from about 1 to about 20 foam layers. The total thickness of the core layer is determined by the overall thickness requirement for the application of the composite structure. The total thickness of the composite structure, most preferably, ranges from about one-half of an inch to about 14 inches. The laminated foam structure can include a high density foam layer, having an average foam density ranging from about 4 to about 12 pounds per cubic foot and thicknesses ranging from about one-thirty second of an inch to about one-half of an inch.

In embodiments in which the skin is a laminate, the outer layer of the skin, preferably, is of a higher density material than the adjacent layer. In the laminated skin structure, the preferred skin, preferably, has an average density of about 18 pounds per cubic foot and a thickness of about 0.010 inch, which is laminated to an outer skin of foam having an average density of 6 per cubic foot and a thickness of one-sixteenth of an inch. The laminated skin structure gives better resistance to creasing in flexure, which is important, for example, in the water sports applications, such as body boards.

The composite structures and their potential applications are varied. For example, a composite structure, with a total thickness ranging from about one-fourteenth of an inch to about 8 inches, is useful in packaging. The low density foam core contributes to a low weight of the total package, while the high density of the skin provides aesthetic improvement, improved load spreading properties, and the ability to print on the article. The skin has a higher density, generally, as a result of smaller cell size. As a result, the surface of the skin is denser and smoother than the surface of the low density core and has the appearance of a highly cross-linked surface.

In another example, a 2 inch composite structure can be used in exercise equipment, such as gym mats, where the high density skin gives improved load spreading and resistance to damage resulting from heavy use. In another example, a 1 inch composite structure can be used as a construction eaves filler, where the high density skin gives the structure improved compression resistance, a more durable surface, and improved die cutting characteristics. In another example, a 2 inch composite structure can be used in the water sports industry for making body boards, where the improved flexural strength gives resistance to bending and creasing, as well as fatigue resistance. The embodiments depicted in FIG. 3 are examples of structures that can be used in water sports, exercise, and construction applications. In each of the preceding examples, the composite structures, generally, provides for overall weight reductions over an extruded plank construction, increased compression resistance, and improved load spreading behavior.

Assorted shapes can be cut for the composite structures with either solid or foamed cores. The shape is configured for particular end applications (e.g., to fit into an end product). Alternatively, the structure is cut to form a hinge or an expansion region so that the structure can be folded and/or expanded into different shapes. For example, the core of the composite structure can be cut to form a piece (i.e., packing member), leaving a section of the skin intact in one region of the perimeter of the piece so that the skin can act as a hinge or an expansion region. The piece can be positioned in the plane of the composite structure from which it was cut (i.e., in a collapsed or closed form). Alternatively, the piece can be positioned out of the plane of the composite structure (i.e., in an expanded or open form). By tapering the piece, it is possible to form a locking mechanism to hold the piece in the expanded or collapsed form. In the expanded form, the area formerly occupied by the piece forms a void in the composite structure that can be sized to fit a product for packaging.

Cutting of pieces or shapes can be achieved by hand using knives or scissors. A more efficient method is to use sharpened steel rule dies of forged dies to cut the entire shape all at once (i.e., die cutting). In this process, a hydraulic press, or a “Clicker” type press, operating at pressures ranging from 50 to 150 pounds per square inch and at room temperature, can be used to press the die into the laminated polymer structure. Once the press has forced the die through the material, completely severing it from the rest of the structure, the “puzzle-like” piece can be removed for use. In order to form a hinge or an expansion region from the skin to link the cut piece to the remainder of the composite structure, a section of the die is offset so that it cuts through the core, but does not cut through or sever the skin.

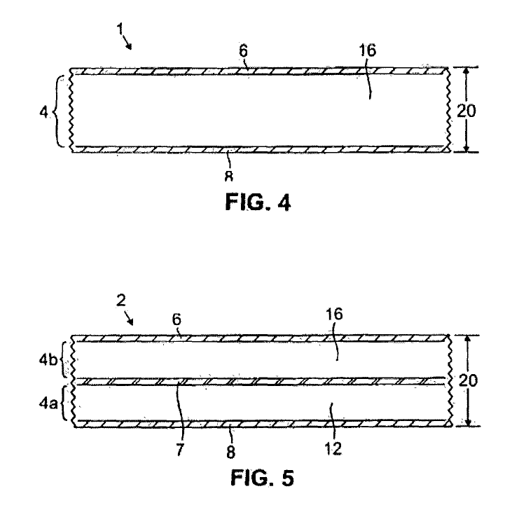

The embodiments depicted in FIG. 1, FIG. 2, FIG. 4, or FIG. 5 are examples of structures that can be used in packaging applications. FIG. 4 is a drawing depicting a non-laminated composite structure having a low density core and two high density material skins. FIG. 5 is a drawing depicting a non-laminated composite structure having a low density core with a high density foam layer and two high density material skins.

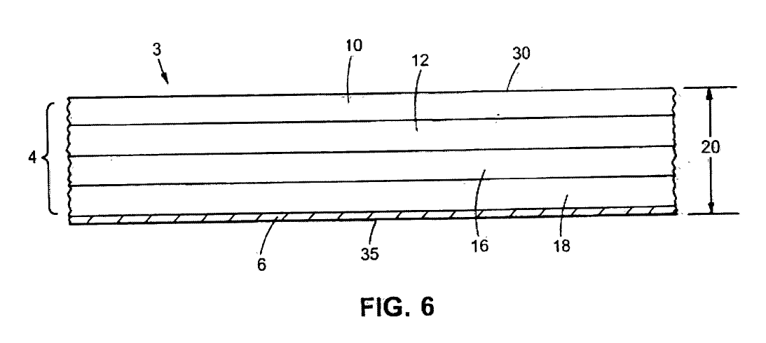

Referring to FIG. 6, the composite structure 3 is a flat and has a core 4 laminated to a first skin 6 on one surface of core 4. Structure 3 has a top surface 30, which is an exposed surface of core 4, and a bottom surface 35, which is an exposed surface of skin 6. Skin 6 is generally a material having an average density greater than about 18 pounds per cubic foot and thicknesses of less than or equal to about five-sixteenths of an inch. Core 4 is a laminated foam structure with multiple layers. Alternatively, core 4 can be a single section of foam. In preferred embodiments, core 4 has four layers, including foam 10, foam 12, foam 16, and foam 18. The foams 10, 12, 16, and 18, in core 4, each have average foam densities ranging from about 1.5 to about 2.5 pounds per cubic foot, and thicknesses ranging from about three-eighths of an inch to about five-eighths of an inch. The core foams are preferably polyolefin foams, such as a polyethylene or polypropylene foam that is closed cell in nature. Core 4, and its constituent foams 10, 12, 16 and 18, have average foam densities that are low relative to skin 6. Skin 6 provides strength to the structure, and can act as a hinge or an expansion region when the structure of the foam is properly cut. The structure 3 has a total thickness 20 which generally ranging from about 1 to about 14 inches. The composite structure is effectively bonded together using heat lamination to enhance recyclability of the material, however, glue or adhesive or any other material useful for lamination may be used to effect the bond. Structures according to FIG. 6 can be used in packaging applications.

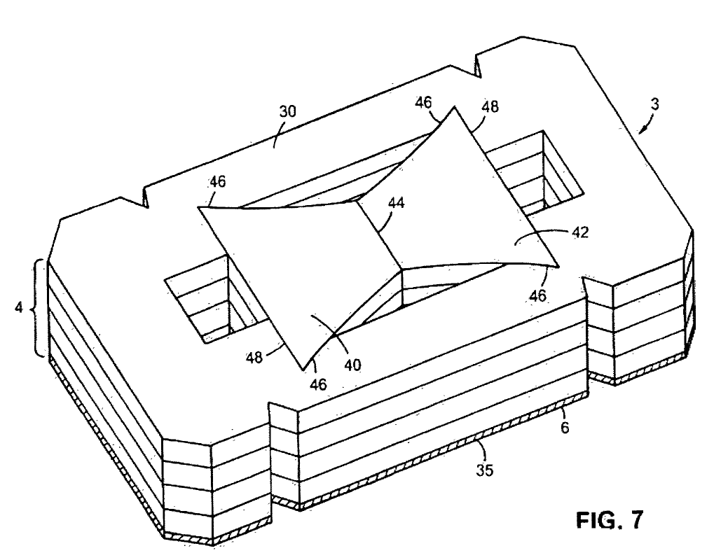

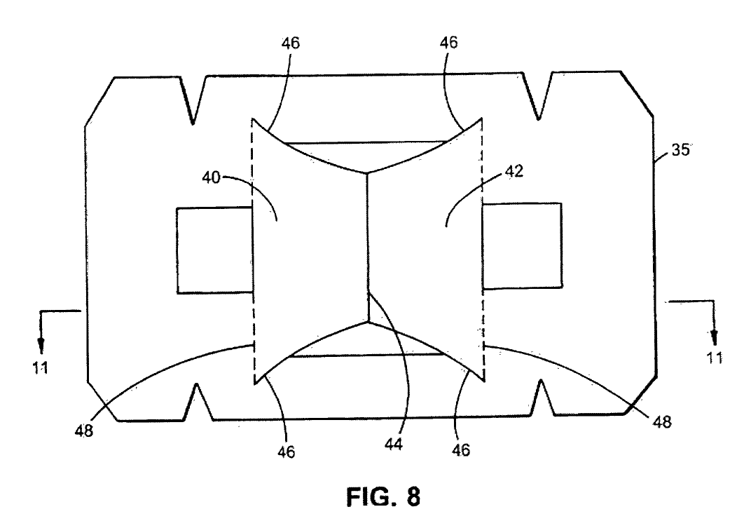

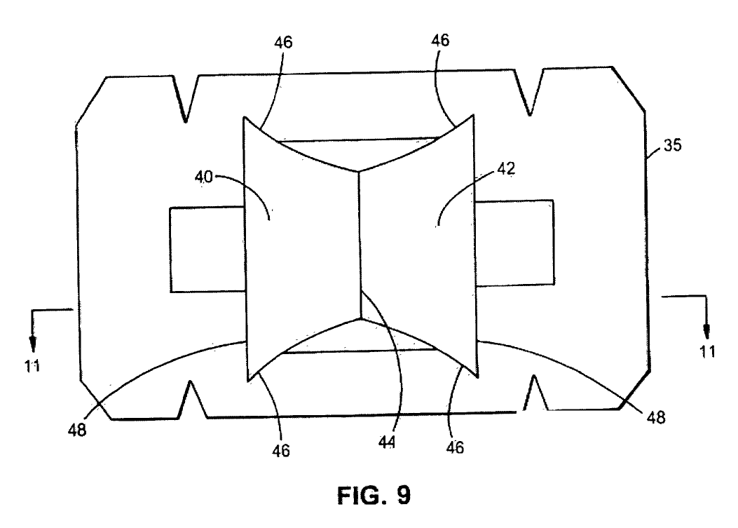

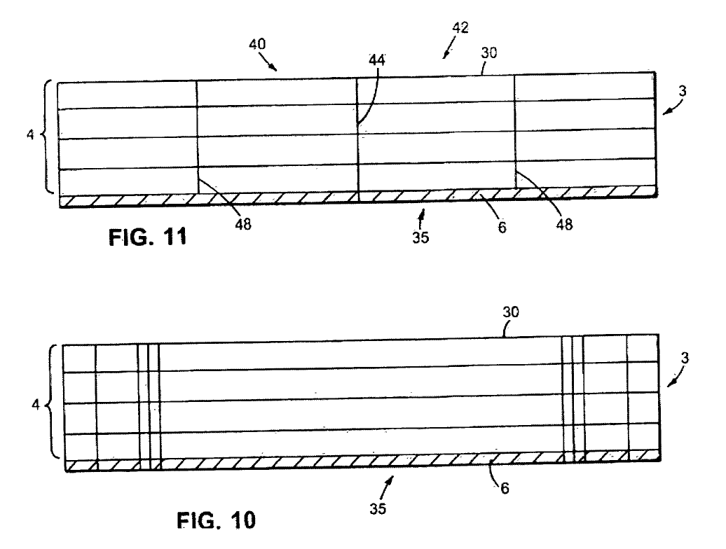

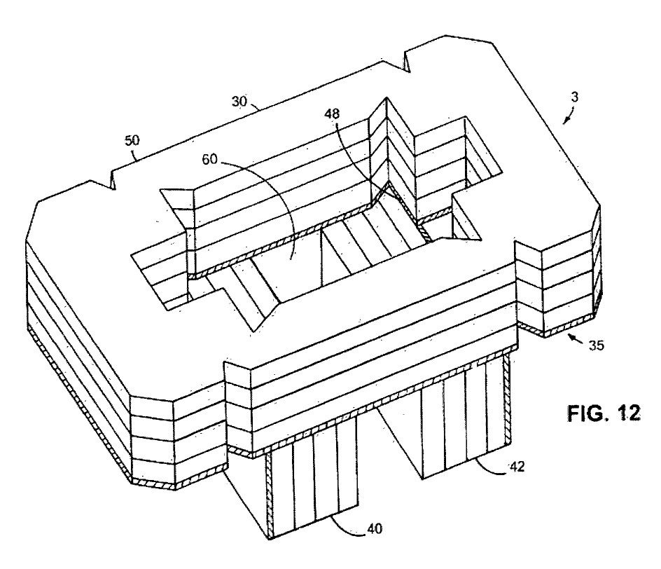

Referring to FIGS. 7-11, composite structure 3 can be die cut for packaging applications to form a collapsible packaging system that is shown in the collapsed configuration. Piece 40 (i.e., a first packing member) and piece 42 (i.e., a second packing member) are cut from structure 3 by completely cutting through core 4 and skin 6 at head slit 44 and side slits 46. Referring to FIG. 11, tail slit 48 is cut from the top surface 30 through core 4 and not through skin 6, forming a hinge or an expansion region between piece 40 (or piece 42) and the remainder of the composite structure. Tail slit 48 does not extend to bottom surface 35. The die cut can be designed, so that sections of the composite structure can be removed altogether to lower the total weight of the collapsible packaging system.

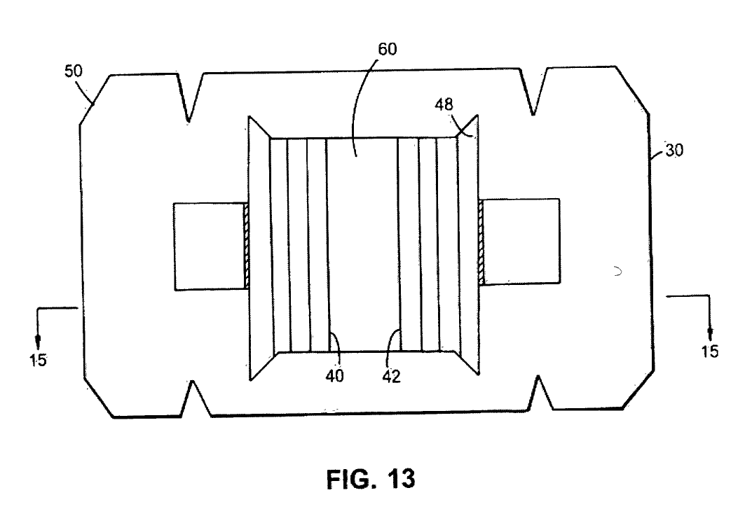

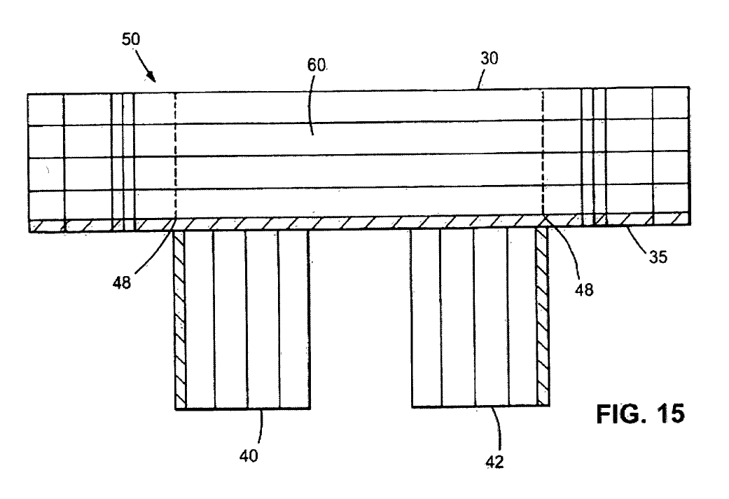

Referring to FIGS. 12-15, die cut composite structure 3 depicted in FIGS. 7-11 can be expanded to form end cap 50 for use in packaging. Piece 42 is extended out of the plane of the composite structure by bending along the hinge or an expansion region formed at tail slit 48 onto bottom surface 35. Piece 40 is, similarly, extended to form the expanded configuration. In this expanded configuration, well 60 is formed.

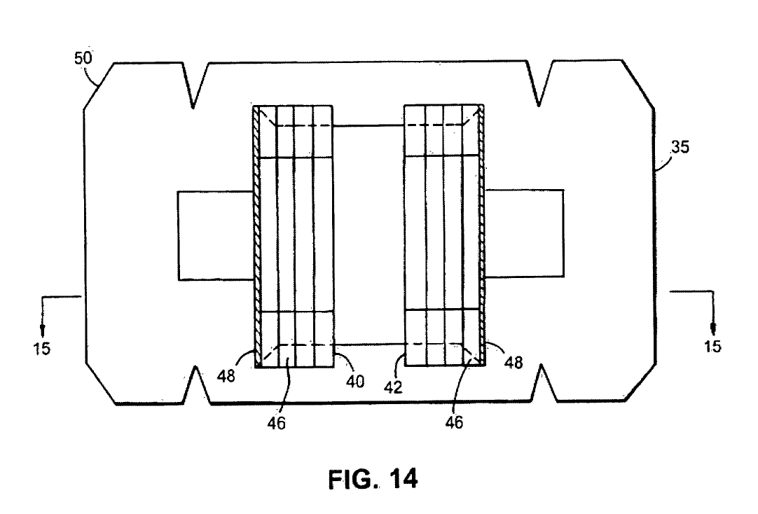

Pieces 40 and 42 are tapered, having wider ends at tail slits 48 than at head slit 44. Referring to FIG. 14, the tapering of pieces 40 and 42 allow them to lock into place, when extended from the composite structure and the hinge or when an expansion region is bent at an angle 90° to bottom 35.

The dimensions of well 60 are suited to fit end cap 50 onto, for example, each end of a packaged product. The outer dimensions of end cap 50 are suitable securing the product having two end caps in a carton, box, or other suitable container.

When not being used for packaging a product, the expanded configuration of end cap 50 can be collapsed back into the space-efficient composite structure form for storage or transport of the collapsible packaging system. The hinge or expansion region structures allow the packaging system to be efficiently reused.

Die cutting is the preferred operation for cutting the composite structures, since it is simple to carry out and repeat (e.g., automate). The cutting operation is the only necessary step for producing protective collapsible packaging systems directly from the composite structures. Composite structures, having more than one high density skin (i.e., a skin on both surfaces of the structure) can be cut in a similar manner to form the hinges or expansion regions and collapsible packaging systems. For example, the additional skin can be added for additional structural stability and support.

The foams are generally foamed polymers and polymer blends. Examples of suitable polymers include, single-site initiated polyolefins, low density polyethylene (LDPE), high density polyethylene (HDPE), linear low density polyethylene (LLDPE), ethylene-propylene rubber, ethylene-propylene-diene monomer terpolymer (EPDM), polystyrene, polyvinylchloride (PVC), polyamides, polyacrylates, celluloses, polyesters, polyhalocarbons, and copolymers of ethylene with propylene, isobutene, butene, hexene, octene, vinyl acetate, vinyl chloride, vinyl propionate, vinyl isobutyrate, vinyl alcohol, allyl alcohol, allyl acetate, allyl acetone, allyl benzene, allyl ether, ethyl acrylate, methyl acrylate, acrylic acid, or methacrylic acid. The polymer blends can also include rubber materials such as polychloroprene, polybutadiene, polyisoprene, polyisobutylene, nitrile-butadiene rubber, styrene-butadiene rubber, chlorinated polyethylene, chlorosulfonated polyethylene, epichlorohydrin rubber, polyacrylates, butyl rubber, or halobutyl rubber. The rubber material can be peroxide-cured or vulcanized. Preferred resins include single-site initiated polyolefins, LDPE, LLDPE, polypropylene, polystyrene, or ethylene copolymers such as ethylene-vinyl acetate copolymer (EVA), or ethylene-ethyl acrylate copolymer (EEA).

The single-site initiated polyolefin resins are derived from ethylene polymerized with at least one comonomer chosen from alpha-unsaturated C₃-C₂₀ olefin comonomers. Preferably, the alpha-unsaturated olefins have from 3 to 16 carbon atoms, most preferably, 3 to 8 carbon atoms. Examples of such alpha-unsaturated olefin comonomers used as copolymers with ethylene include, but are not limited to, propylene, isobutylene, 1-butene, 1-hexene, 3-methyl-1-pentene, 4-methyl-1-pentene, 1-octene, 1-decene, 1-dodecene, styrene, halo- or alkyl-substituted styrene, tetrafluoroethylene, vinylcyclohexene, and vinylbenzocyclobutane. The comonomer content of the polyolefin resins generally ranges from about 1 mole percent to about 32 mole percent, preferably, about 2 mole percent to about 26 mole percent, and most preferably, from about 6 mole percent to about 25 mole percent.

The copolymer can include one or more C₄-C₂₀ polyene monomers. Preferably, the polyene is a straight-chain, branched chain or cyclic hydrocarbon diene, most preferably, having 6 to 15 carbon atoms. It is also preferred that the diene be non-conjugated. Examples of such dienes include, but are not limited to, 1,3-butadiene, 1,4-hexadiene, 1,6-octadiene, 5-methyl-1,4-hexadiene, 3,7-dimethyl-1,6-octadiene, 3,7-dimethyl-1,7-octadiene, 5-ethylidene-2-norbornene, and dicyclopentadiene. Especially preferred, is 1,4-hexadiene.

The preferred single-site initiated polyolefin resins include either ethylene/alpha-unsaturated olefin copolymers or ethylene/alpha-unsaturated olefin/diene terpolymers.

Single-site initiated polyolefin resins can be prepared using single-site initiators. One class of a single-site initiators of particular interest are the metallocene initiators which are described, for example, in J. M. Canich, U.S. Pat. No. 5,026,798, in J. Ewen, et al., U.S. Pat. No. 4,937,299, in J. Stevens, et al., U.S. Pat. No. 5,064,802, and in J. Stevens, et al., U.S. Pat. No. 5,132,380, each of which are incorporated herein by reference. These initiators, particularly those based on group 4 transition metals, such as zirconium, titanium and hafnium, are extremely high activity ethylene polymerization initiators. The single-site initiators are versatile.

The polymerization conditions, such as a initiator composition and reactor conditions, can be modified to provide polyolefins with controlled molecular weights (e.g., in a range from 200 g mol⁻¹ to about 1 million or higher g mol⁻¹) and controlled molecular weight distributions (e.g., M_{w}/Mₙ in a range from nearly 1 to greater than 8, where M_{w} is the weight average molecular weight and Mₙ is the number average molecular weight). Molecular weights and molecular weight distributions of polymers can be determined, for example, by gel permeation chromatography.

When the single-site initiated polyolefins are copolymers, the composition distribution breadth index (CDBI) is generally at least fifty percent and most preferably, at least seventy percent. The CDBI is a measurement of the uniformity of distribution of comonomers among the individual polymer chains having a comonomer content within fifty percent of the median bulk molar comonomer content.

Preferred single-site initiated polyolefin resins are described, for example, in S. Y. Lai, et al., U.S. Pat. Nos. 5,272,236, 5,278,272, and 5,380,810, in L. Spenadel, et al., U.S. Pat. 5,246,783, in C. R. Davey, et al., U.S. Pat. No. 5,322,728, in W. J. Hodgson, Jr., U.S. Pat. No. 5,206,075, and in F. C. Stehling, et al., WO 90/03414, each of which is incorporated herein by reference. The resins contain varying amounts of short-chain and long-chain branching, which depend, in part, on the processing conditions.

Some single-site initiated polyolefin resins are available commercially from Exxon Chemical Company, Houston, Tex., under the tradename Exact™, and include Exact™ 3022, Exact™ 3024, Exact™ 3025, Exact™ 3027, Exact™ 3028, Exact™ 3031, Exact™ 3034, Exact™ 3035, Exact™ 3037, Exact™ 4003, Exact™ 4024, Exact™ 4041, Exact™ 4049, Exact™ 4050, Exact™ 4051, Exact™ 5008, and Exact™ 8002. Other single-site initiated resins are available commercially from Dow Plastics, Midland, Mich. (or DuPont/Dow), under the tradenames Engage™ and Affinity™, and include CL8001, CL8002, EG8100, EG8150, PL1840, PL1845 (or DuPont/Dow 8445), EG8200, EG8180, GF1550, KC8852, FW1650, PL1880, HF1030, PT1409, CL8003, and D8130 (or XU583-00-01). Most preferably, the single-site initiated polyolefin resins are selected from the group consisting of Exact™ 3024, Exact™ 3031, Exact™ 4049, PL1845, EG8200, and EG8180.

The preferred foams include polyethylene, such as, for example, single-site initiated polyethylenes or LDPE. LDPE resins are described, for example, in “Petrothene® Polyolefins . . . A Processing Guide,” Fifth Edition, Quantum USI Division, 1986, pages 6-16, incorporated herein by reference. Some LDPE resins are commercially available from Exxon Chemical Company, Houston, Tex., Dow Plastics, Midland, Mich., Novacor Chemicals (Canada) Limited, Mississauga, Ontario, Canada, Mobil Polymers, Norwalk, Conn., Rexene Products Company, Dallas, Tex., Quantum Chemical Company, Cincinnati, Ohio, and Westlake Polymers Corporation, Houston, Tex. Commercially available LDPE resins, include Eastman 1924P, Eastman 1550F, Eastman 800A, Exxon LD 117.08, Exxon LD 113.09, Dow 535I, Dow 683, Dow 760C, Dow 768I, Dow 537I, Novacor LF219A, Novacor LC05173, Novacor LC0522A, Mobil LMA-003, Mobil LFA-003, Rexene 2018 (7018), Rexene 1023, Rexene XO 875, Rexene PE5050, Rexene PE1076, Rexene PE2030, Quantum NA953, Quantum NA951, Quantum NA285-003, Quantum NA271-009, Quantum NA324, Westlake EF606AA, Westlake EF612, and Westlake EF412AA.

The foams can be cross-linked, however, non-cross-linked foams also can be made. The foams can be cross-linked with peroxides, UV irradiation, or by silane-grafting. The use of silane-grafting for cross-linking in polymer foams is described, for example, in U.S. Ser. No. 08/308,801, and in U.S. Ser. No. 08/638,122.

The foam can, preferably, be a polymer blend including at least one silane-grafted single-site initiated polyolefin resin. The preferred level of silane-grafted single-site initiated polyolefin resin, in weight percent of the total polymeric content of the foam, ranges from about 2 percent to about 30 percent, more preferably from about 3 percent to about 18 percent. The single-site initiated polyolefin resin can be silane-grafted before blending with other polymer resins. Alternatively, the foam can be a polymer blend. The blend can be silane-grafted.

Silane-grafting of the polyolefin resin or resin blend occurs when the polymer backbone is activated and reacts with a silane reagent to form the graft copolymer. The silane-graft can include a subsequently cross-linkable moiety in the graft chain. For example, the cross-linking can occur under warm, moist conditions, when the cross-linkable moiety is hydrolyzable, optionally, in the presence of a suitable catalyst. Levels of cross-linking can be adjusted by varying the amount of silane-grafting introduced to the polymer blend. Alternatively, cross-linking can be introduced by reaction of the polymers with peroxides. UV irradiation of the polymers can also be used to introduce cross-linking.

A cross-linking graft can include other monomers, such as di- and tri-allyl cyanurates and isocyanurates, alkyl di- and tri-acrylates and methacrylates, zinc dimethacrylates and diacrylates, styrenes, divinylbenzene, and butadiene.

The graft initiator, or peroxide cross-linking agent can be a free radical generating species, for example, a peroxide. Examples of peroxides include dicumylperoxide, 2,5-dimethyl-2,5-di(t-butylperoxy)hexane, 1,1-bis(t-butylperoxy)-3,3,5-trimethylcyclohexane, 1,1-di-(t-butylperoxy)cyclohexane, 2,2′-bis(t-butylperoxy)diisopropylbenzene, 4,4′-bis(t-butylperoxy)butylvalerate, t-butylperbenzoate, t-butylperterephthalate, and t-butyl peroxide. Most preferably, the peroxide is dicumylperoxide or 2,2′-bis(t-butylperoxy)diisopropylbenzene.

The silane-grafted polymer can be cross-linked by exposure to moisture to effect silanol condensation reactions of the hydrolyzable groups of the pendant silane-grafts. Cross-linking develops through hydrolysis of the silane Y groups to form silanols which condense to form siloxanes. The condensation of silanols to siloxanes is catalyzed by metal carboxylates such as, for example, dibutyl tin dilaurate or dibutyl tin maleate. The most preferred silanol condensation catalyst is dibutyl tin dilaurate.

The cross-linking of silane-grafted polymers can be induced by the presence of atmospheric moisture, steam, or hot water. Cross-linking can take place predominantly (e.g., more than fifty percent of the potential cross-linking) prior to expansion (or extrusion) of the foam. Alternatively, the cross-linking can take place predominantly after expansion of the foam.

Exposure of the compositions to high energy radiation to induce cross-linking can be accomplished at dosages of ionizing radiation in the range of about 0.1 to about 40 Megarads, and preferably, at about 1 to about 20 Megarads. The amount of cross-linking can be appropriately controlled by adjusting the dosage of high energy radiation.

Regardless of the method of cross-linking used, acceptably flexible articles, particularly foamed articles, can only be obtained in certain ranges of cross-linking density or level, which is related to the amount of silane-grafting in the blend. Too much cross-linking can render the material inelastic. In a foam, this can result in less than optimal expansion and greater than optimal density for a given level of foaming agent. Too little cross-linking can be detrimental to physical properties, such as compression set properties or thermal resistance, for example. It is important to choose cross-linking levels that afford materials with particular desired properties. The silane-grafting and resulting cross-links increase the melt strength of the composition. The cross-linking levels can be determined by establishing the gel content of the composition, for example, by extraction with a solvent, such as xylenes.

The foams can be prepared using physical or chemical foaming agents. Physical foaming agents include low molecular weight organic compounds including C₁-C₆ hydrocarbons, such as acetylene, propane, propene, butane, butene, butadiene, isobutane, isobutylene, cyclobutane, cyclopropane, ethane, methane, ethene, pentane, pentene, cyclopentane, pentene, pentadiene, hexane, cyclohexane, hexene, and hexadiene, C₁-C₅ organohalogens, C₁-C₆ alcohols, C₁-C₆ ethers, C₁-C₅ esters, C₁-C₅ amines, ammonia, nitrogen, carbon dioxide, neon, or helium. Chemical foaming agents include, for example, azodicarbonamide, p-p′-oxybis(benzene)sulfonyl hydrazide, p-toluenesulfonyl hydrazide, p-toluenesulfonyl semicarbazide, 5-phenyltetrazole, ethyl-5-phenyltetrazole, dinitrosopentamethylenetetramine, and other azo, N-nitroso, semicarbazide, sulfonyl hydrazides, carbonate, and bicarbonate compounds that decompose when heated. The preferred foaming agents include azodicarbonamide or isobutane.

The foam can be partially or extensively cross-linked prior to expansion, or can be extensively cross-linked after expansion.

Additional additives in the foam composition can dramatically effect the properties of the foam. These include gas exchange additives and cell nucleating agents, such as zinc stearate and talc, respectively. The preferred gas exchange additive concentration in the foam ranges from about 0.5 to about 2.0 percent. The preferred cell nucleating agent concentration in the foam ranges from about 0.05 to about 2.0 percent. The foam can also include gas exchange additives, also known as cell-structure stabilizers, such as, for example, fatty acids, fatty acid carboxylate salts (e.g., zinc stearate), fatty acid esters (e.g. glycerol monostearate), or fatty acid amides, assist in the gas exchange process and the aging of the foams.

Other additives, alone or in combination, can be added to the foam compositions, including antioxidants (e.g., hindered phenolics such as Irganox 1010, phosphites, such as Irgafos 168, or polymerized trimethyl-dihydroquinoline, such as Agerite AK, Resin D or Flectol H), ultra-violet stabilizers, thermal stabilizers, antistatic components, flame retardants, pigments or colorants, and other processing aids.

The high-density layers are prepared from commercially-available films. Non-limiting examples of resins useful for making the non-foam film and/or high density foam (i.e., above about 18 pounds per cubic foot) film, for applying on the low-density foam layers, are provided in the tables below.

| Low Density Polyethylene Resins | Melt Index | Density |
|---|---|---|
| (LDPE) | (g/10 min) | (g/cm³) |
| Dow Chemical LDPE 1321 | 0.2 | 0.921 |
| Dow Chemical LDPE 133A | 0.2 | 0.923 |
| Dow Chemical LDPE 135A | 0.2 | 0.923 |
| Dow Chemical LDPE 529A | 2.0 | 0.913 |
| Dow Chemical LDPE 582R | 3.5 | 0.923 |
| Chemical LDPE 410 R | 2.0 | 0.925 |

| Low Density Polyethylene Resins | Melt Index | Density |
|---|---|---|
| (LDPE) | (gl/10 min) | (g/cm³) |
| DSM Stamylan 2004 TX 37 | 4.7 | 0 921 |
| DSM Stamylan 2102 TN37 LDPE | 2.5 | 0 921 |
| DSM'S Stamylan LD 2102TX00 | 1.98 | 0.9215 |
| Eastman 1550 | 3.5 | 0.920 |
| Eastman 808 | 7.0 | 0.917 |
| Huntsman PE 2030 | 5.0 | 0.919 |
| Westlake EF 610 | 3.8 | 0.920 |
| Westlake EC 479 | 5.7 | 0.921 |
| Westlake EF607 | 6.0 | 0.919 |

| Linear Low Density Polyethylene | Melt Index | Density |
|---|---|---|
| Resins (LLDPE) | (g/10 min) | (g/cm³) |
| ExxonNTX-112 | 0.7 | 0.923 |
| ExxonLL-3013 | 1.3 | 0.917 |
| ExxonLL-1001 | 1.0 | 0.918 |
| Exxon LL-3404.42 | 4.0 | 0.942 |
| DOWLEX NG-2085 LLDPE | 1.0 | 0.920 |
| DOWLEX 2071D LLDPE | 0.9 | 0.928 |
| DOWLEX 2036AC LLDPE | 2.5 | 0.935 |
| DOWLEX 2037 LLDPE | 2.5 | 0.935 |

| Linear Low Density Polyethylene | Melt Index | Density |
|---|---|---|
| Resins (mLLDPE) Metallocene | (g/10 min) | (g/cm³) |
| ExxonMobil Exceed 1023CA | 1.0 | 0.923 |
| ExxonMobil Exceed 2718 CB | 2.7 | 0.918 |
| ExxonMobil Exceed 3518 CB | 3.5 | 0.918 |
| ExxonMobil Exceed 2718 CB | 2.7 | 0.918 |

| | MFR | Density |
|---|---|---|
| Polypropylene (HMS) | (g/10 min) | (g/cm³) |
| Basell's PF 814 | 3.0 | 0.90 |

The thickness of high-density layers used in accordance with the invention, typically, ranges from about 0.0005 to about 0.300, preferably from about 0.001 to about 0.015, and more preferably from about 0.002 to about 0.010.

The foam and high density materials can take virtually any physical configuration, preferably the form of a sheet, plank, or other regular or irregular extruded profile or bead molded shape. Sheets are extruded from flat die or circular dies depending on the foam density and have thicknesses ranging from about 0.001 inch to about 1 inch and widths up to 82 inches or more. Parts of smaller size, depending on requirements of the application, can be cut from the sheets. For example, a board with typical dimensions of about 20 inches by about 30 inches may be cut from the larger sheets, and further shaped by molding or machining to produce a body board for water sports.

Alternatively, the foams can be configured as planks, extruded from flat dies, with plank thicknesses ranging from about 1 inch to about 4.5 inches and widths ranging from about 24 inches to about 48 inches. Planks and sheets can be laminated by direct application of heat or adhesives to the interface between two or more planks. In preferred embodiments, it is not necessary to add an adhesive to the interface to laminate the planks or sheets.

Lamination can be achieved by heating the laminate interface, film lamination, or by using an adhesive. These techniques are, generally, well known in the composite structure fabrication industries. Heat lamination is a process in which two sheets of foam or other materials are brought together under pressure and heated to join the materials.

As an example, foam can be taken from rolls of approximately about one-half of an inch thickness, about 48 inches width about 400 feet in length. The foam sheets are fed together with pressure exerted by two turning rollers. Immediately prior to the materials meeting in the nip of the rollers, heat is applied to the surfaces which are about to be pressed together. The heat can be supplied by hot air guns, gas-fired flames, infrared heaters, or combinations thereof.

Heat can be applied to both foam sheets, or only to one. The heat makes the foam surface tacky by creating local regions of melting on the surface. The foam sheets passing through the nip of the rollers are joined by a bond upon cooling.

A similar laminate can be made by applying an adhesive to one or both sheets prior to the foam passing through the nip of the rollers (nip rollers) or by extrusion of a thin continuous layer of polymer onto one surface immediately prior to the foam passing through the nip rollers. By choosing a film material which is compatible with the substrates, a laminate is formed. Adhesives include, but are not limited to, rubber, epoxy, and acrylic adhesives. Heat and film lamination methods are preferred, since those methods can avoid the use of solvents in the lamination process.

In adhesive lamination, the foam articles can be coated with an adhesive using any of a number of conventional coating techniques, including reverse roll coating, knife over roll coating, or extrusion coating. Optionally, the coated substrate can be passed through an in-line dryer to remove solvent or water, or to chemically alter the coating. Machinery for coating these tapes can be purchased from equipment suppliers, such as Ameriflex Group Incorporated, Black Clawson Converting Machinery Corporation, Inta-Roto, Incorporated, Klockner Er-We-Pa, and Wolverine Massachusetts Corporation. The following specific examples are to be construed as merely illustrative, and not limited, of the remainder of the disclosure.

### EXAMPLES

EXAMPLE 1 composite structure having four low density foam layers in a core and a higher density skin on each surface of the core can be manufactured using the following steps:

### Step 1

Four layers of one-half of an inch polyethylene foam with a density of 1.7 pounds per cubic foot are continuously laminated from roll stock using hot air injected between the layers which are then pressed together between nip rollers. Composite structures are cut after lamination to make handling easier. The 1.7 pounds per cubic foot laminated foam core had a total thickness of 2 inches. Using the aforementioned laminator system, one layer of foam can be laminated at a time until the desired core thickness is obtained.

### Step 2

A layer of 30 pounds per cubic foot polyethylene that is 0.006 inches thick is laminated to one side of the foam core (i.e., the 2 inch thick, 1.7 pounds per cubic foot laminated foam core) by feeding the 2 inch thick laminated foam core into the laminator used in step 1. The 30 pounds per cubic foot layer is fed from roll stock. The resultant composite structures are cut as in step 1.

### Step 3

Step 2 is repeated to laminate a second 30 per cubic foot polyethylene layer that is 0.006 inches thick to the other side of the 1.7 laminated foam core, resulting in a composite structure, consisting of a core of four laminated 1.7 pounds per cubic foot polyethylene foams with a skin of 30 pounds per cubic foot polyethylene on each side of the core and having a total thickness of 2.012 inches (i.e., an 30/1.7/30 composite density composite structure, hereafter referred to as Example 1). Example 1 has a structure similar to that shown in FIG. 1.

### Example 1A

The 30 per cubic foot polyethylene material in EXAMPLE 1 is printed on either of its surfaces, and the surface opposite the printed surface is laminated to the core surface.

### Example 2

A composite structure having four low density foam layers in a core and a two-layer higher density skin on each surface of the core can be manufactured using the following steps:

### Step 1

A laminated foam structure having a four-ply laminated foam core of 2 pounds per cubic foot, one-half inch thick polyethylene foam sheets is produced by the process of step 1 of Example 1.

### Step 2

A layer of 30 pounds per cubic foot polyethylene that is 0.006 inches thick is laminated to each side of the four-ply laminated foam core, by the process of step 2 and step 3 of Example 1 to afford an 30/2/30 composite density composite structure.

### Step 3

A layer of 20 pounds per cubic foot polyethylene that is 0.010 inches thick is laminated to each side of the 30/2/30 composite structure of step 2, by the process of step 2. The final composite structure has a core of four laminated 2 pound per cubic foot polyethylene foams with a skin of 30 pound per cubic foot polyethylene material and an outer skin of 20 pounds per cubic foot polyethylene material on each side of the core and has a total thickness of 2.032 inches (i.e., an 20/30/2/30/20 composite density laminate composite structure, hereafter referred to as Example 2). Example 2 has a structure similar to that shown in FIG. 3.

### Example 3

A composite structure having four low density foam layers in a core and a two-layer higher density skin on each surface of the core can be manufactured using the following steps:

### Step 1

A four-ply laminated foam core of 2 pounds per cubic foot, one-half inch thick polyethylene foam sheets is produced, by the process of step 1 of Example 1.

### Step 2

A layer of non-foam polyethylene film that is 0.003 inches thick is laminated to each side of the laminated foam structure of step 1. The final laminated foam structure has a core of four laminated 2 pound per cubic foot polyethylene foams, with an outer skin of non-foam film on each side of the core and has a total thickness of 2.006 inches (i.e., an non-foam film/2/non-foam film composite structure, hereafter referred to as Example 3). Example 3 has a structure similar to that shown in FIG. 3.

### Example 3A

The non-foam film in EXAMPLE 3 is printed on one of its surfaces and film is laminated to the foam core with either the printed surface against or away from the core surface.

### Example 3B

The non-foam film in EXAMPLE 3 is printed on either of its surfaces and it is laminated to a second non-foam film. The film/film composite is laminated to the foam core so that the printing is visible.

### Example 3C

The non-foam film in EXAMPLE 3 is printed on either of its surfaces, and the printed surface is laminated to foam that has a density greater than 18 pounds per cubic foot, and the laminated film/foam composite is then laminated to the core surface with the printed surface facing away from the foam core, so that the printing is visible.

### Example 4

A composite structure having four low density foam layers in a core and a two-layer higher density skin on each surface of the core can be manufactured using the following steps:

### Step 1

A four-ply laminated foam core of 2 pound per cubic foot, one-half inch thick polyethylene foam sheets is produced by the process of step 1 of Example 1.

### Step 2

A layer of 30 pound per cubic foot polyethylene that is 0.004 inches thick is laminated to each side of the four-ply laminated foam core by the process of step 2 and step 3 of Example 1 to afford an 30/2/30 composite structure.

### Step 3

A layer of non-foam polyethylene film that is 0.002 inches thick is laminated to each side of the 30/2/30 composite structure of step 2, by the process of step 2. The final composite structure has a core of four laminated 2 pound per cubic foot polyethylene foams, with a skin of 30 pounds per cubic foot foam and an outer skin of non-foam film on each side of the core and has a total thickness of 2.012 inches (i.e., an non-foam film/30/2/30/non-foam film composite density composite structure, hereafter referred to as Example 4). Example 4 has a structure similar to that shown in FIG. 4.

### Example 5

A laminated foam structure is made according to Example 1, except the layer of 30 pounds per cubic foot polyethylene is replaced with a similar layer having an average density of about 60 pounds per cubic foot.

### Example 6

A laminated foam structure is made according to Example 1, except the layer of 30 pounds per cubic foot polyethylene is replaced with a similar layer having an average density of about 50 pounds per cubic foot.

### Example 7

A laminated foam structure is made according to Example 1, except the layer of 30 pounds per cubic foot polyethylene is replaced with a similar layer having an average density of about 20 pounds per cubic foot, and is 0.010 inches thick.

What is claimed is:

1. A composite structure, comprising:
a first article, comprising:
a surface; and
a material having an average density that is greater than 18 pounds per cubic foot; and
a second article, comprising:
a foam having at least two elements separated by at least one of a bending and expanding region that is at least one of a cut, slit, gap and a crease in a core, and whereby the composite structure is at least one of folded, expanded, and stretched along the at least one bending an expanding region, and wherein the surface of the first article is laminated to the first surface of the second article.

2. The composite structure of claim 1, wherein the first article has a thickness of about one-half of an inch or less and the second article has an average density ranging from about 0.5 to about 12 pounds per cubic foot and a thickness ranging from about one-fourth of an inch to about 14 inches.

3. The composite structure of claim 1, wherein the first article has print with at least one of text and graphics.

4. The composite structure of claim 3, wherein the print on the first article is on a surface opposite the surface laminated to the second article.

5. The composite structure of claim 3, wherein the print on the first article is on the surface that is laminated to the second article.

6. The composite structure of claim 1, wherein the first article comprises at least two skins that are at least one of adhered and laminated together.

7. The composite structure of claim 6, wherein a surface of one of the at least two skins has at least one of text and graphics on the surface that is laminated to a surface of the other of the at least two skins.

8. The composite structure of claim 2, wherein the second article has an average density of at least about 3 pounds per cubic foot or less, and a thickness ranging from about 0.25 to about 14 inches.

9. The composite structure of claim 8, wherein the first article has an average density ranging from greater than about 18 pounds per cubic foot to less than or equal to about 20 pounds per cubic foot, and a thickness ranging from about 0.0005 to about 0.100 inch.

10. The composite structure of claim 1, wherein the foam is chosen from polyolefins, polyurethanes, polystyrenes, blends of polyolefins and polystyrenes, and copolymers of polyolefins and polystyrenes.

11. The composite structure of claim 10, wherein the polyolefin includes a polyethylene or polypropylene.

12. The composite structure of claim 11, wherein the foam further comprises a single-site initiated polyolefin resin.

13. The composite structure of claim 1, wherein at least a portion of the foam is cross-linked.

14. The composite structure of claim 1, wherein the composite structure is heat laminated.

15. A collapsible packaging system comprising:
a skin, comprising:
a high density material having an average density greater than about 18 pounds per cubic foot;
a core having a surface, wherein the skin is laminated to the surface of the core, and wherein the skin and the core form a composite structure, and wherein the core further comprises:
a first packing member; and
a second packing member; and
a first at least one of a hinged and expansion region, wherein the first at least one of the hinged and expansion region connects the first packing member to the second packing member, wherein the first packing member and the second packing member are formed when the core is at least one of scored and cut entirely through the first at least one of the hinged and expansion region, wherein the system has a storage position and a packing position, and wherein the first at least one of the hinged and expansion region locks when in the packing position.

16. The collapsible packaging system of claim 15, wherein the first at least one of the hinged and expansion region permits clearance between the first packing member, and wherein the second packing member relative to each other about the first at least one of the hinged and expansion region.

17. The collapsible packaging system of claim 15, the first at least one of hinged and expansion region is at least one of a gap and thinned region.

18. The collapsible packaging system of claim 16, wherein the first packing member is coupled about the first at least one of the hinged and expansion region, such that the first packing member is pivotally positioned between the storage position, in which the first packing member is parallel to and contained within a gap in the second packing member, and the packing position, in which the first packing member is oriented transverse to the second packing member.

19. The collapsible packaging system of claim 16, wherein the first packing member is at least in part defined by at first slit extending entirely through the composite structure and the first at least one of the hinged and expansion region.

20. The collapsible packaging system of claim 15, wherein the first packing member is tapered, having a wide end nearest to the first at least one of the hinged and expansion region.

21. The collapsible packaging system of claim 15, wherein the composite structure further comprises:
a second at least one of a hinged and expansion region; and
a third packing member wherein the third packing member is attached to the second packing member by the second at least one of the hinged and expansion region.

22. The collapsible packaging system of claim 21, wherein the second at least one of the hinged and expansion region is at least one of a gap and thinned region.

23. The collapsible packaging system of claim 22, wherein the third packing member is at least in part defined by a second slit extending entirely through the composite structure and the at least one of a gap and thinned region.

24. The collapsible packaging system of claim 23, wherein the at least one of the gap and thinned region permits clearance between the second and the third packing members.

25. The collapsible packaging system of claim 21, wherein the second packing member and the third packing member move relative to each other about the second at least one of the hinged and expansion region.

26. The collapsible packaging system of claim 21, wherein when in the storage position, the first packing member and the third packing member are parallel to and positioned to thin the second packing member, and wherein when in the packing position, the first packing member and the third packing member are generally parallel, forming a well.

27. The collapsible packaging system of claim 26, wherein the well contains a packed item.

28. The collapsible packaging system of claim 15, wherein the core comprises a first foam having an average foam density ranging from about 0.5 to about 6 pounds per cubic foot and a thickness ranging from about one-fourth of an inch to about 14 inches, and the skin has a thickness less than or equal to about one-half of an inch.

29. The collapsible packaging system of claim 21, wherein the first packing member is tapered, having a wide end nearest to the at least one first hinged and expansion region, and the third packing member is tapered, having a wide end nearest to the second at least one hinged and expansion region.

30. The collapsible packaging system of claim 21, wherein the first packing member and the third packing member are oriented such that the first at least one of hinged and expansion region and the second at least one of the hinged and expansion region are located opposite to each other on the composite structure.

31. The collapsible packaging system of claim 15, wherein the core comprises a foam having an average foam density less than or equal to about 3 pounds per cubic foot and a thickness ranging from about one-fourth of an inch to about 5 inches.

32. The collapsible packaging system of claim 15, wherein the skin has a thickness of less than or equal to about one-half of an inch.

33. The collapsible packaging system of claim 15, wherein the skin and the core comprise a polyolefin.

34. The collapsible packaging system of claim 33, wherein the polyolefin comprises at least one of polyethylene and polypropylene.

35. The collapsible packaging system of claim 33, wherein at least one of the skin and the core further comprises a single-site initiated polyolefin resin.

36. The collapsible packaging system of claim 15, wherein at least one of the skin and the core is cross-linked.

37. The collapsible packaging system of claim 15, wherein the composite structure is heat laminated.

38. The collapsible packaging system of claim 15, wherein the core comprises at least one of a non-laminate foam and a bead molded foam.

39. The composite structure of claim 3, wherein the graphics are colored.
